(19) United States
(12) Patent Application Publication
(10) Pub. No.: US 2013/0169037 A1
(43) Pub. Date: Jul. 4, 2013

(54) POWER SUPPLY DEVICE, APPARATUS AND ARRANGEMENT HAVING A POWER SUPPLY DEVICE SUCH AS THIS, AND METHOD FOR SUPPLYING POWER TO AT LEAST ONE TRACK ELEMENT FOR TRACK-GUIDED TRAFFIC

(71) Applicants: Thomas Bieg, Muenchen (DE); Jens-Peter Brauner, Braunshweig (DE); Horst Ernst, Braunschweig (DE); Peter Ziegler, Braunschweig (DE)

(72) Inventors: Thomas Bieg, Muenchen (DE); Jens-Peter Brauner, Braunshweig (DE); Horst Ernst, Braunschweig (DE); Peter Ziegler, Braunschweig (DE)

(73) Assignee: SIEMENS AKTIENGESELLSCHAFT, MUENCHEN (DE)

(21) Appl. No.: 13/822,060

(22) PCT Filed: Aug. 30, 2011
(86) PCT No.: PCT/EP2011/064860

§ 371 Date: Mar. 11, 2013

(30) Foreign Application Priority Data
Sep. 9, 2010 (DE) 10 2010 045 234.3

(51) Int. Cl. B61C 3/00; H02J 17/00

(52) U.S. Cl. CPC B61C 3/00; H02J 17/00
USPC 307/9.1

(57) ABSTRACT

A power supply device, an apparatus and an assembly with the power supply device and a method for supplying power to a track element of a track-bound traffic system. The power supply device for at least one track element of the track-bound traffic has a trackside receiving device for receiving energy which is transmitted actively by electromagnetic induction by a transmitting device or a track-bound vehicle, and a trackside energy storage device for at least partial storage of the energy received by the trackside receiving device. The track element is supplied with electrical power from the trackside receiving device. The power transmission is decoupled in time from the energy transfer from the transmitting device to the trackside receiving device.

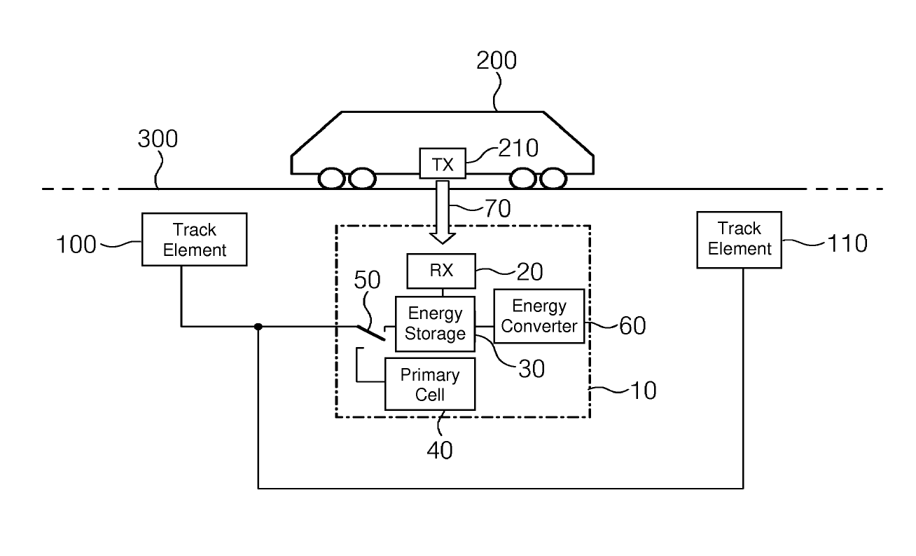

In the field of track-guided traffic, for example, in railroads, magnetic-levitation trains, or track-guided vehicles having rubber tires, a variety of track elements is used. Such track elements may include, for example, wheel sensors, axle counters, switches, signals, or key interlocks. While the track elements differ depending on their type and their respective intended use, track elements for track-guided traffic typically share the common feature of requiring electrical power for their operation. In practice, this means that each track element is normally supplied with electrical power by means of an electrical line by a central power supply facility related to the respective track section. However, supplying the associated line-connected or line-dependent electrical power required for operating the track elements has the disadvantage of involving substantial effort and expense due to the need to lay cables along the track.

The object of the present invention is to specify a power supply device for at least one track element for track-guided traffic that can be implemented in a comparatively simple manner while at the same time being versatile.

This object is achieved according to the invention by a power supply device for at least one track element for track-guided traffic, having a trackside receiving device for receiving energy which is transmitted actively by means of electromagnetic induction by a transmitting device of a track-guided vehicle, and having a trackside energy storage device for at least partial storage of the energy received by the trackside receiving device and for supplying the at least one track element with electrical power from the transmission of the power from the transmitting device to the trackside receiving device, with this supply being decoupled in time.

The power supply device according to the invention has a trackside receiving device for receiving energy which is transmitted actively by means of electromagnetic induction by a transmitting device of a track-guided vehicle. Such an active transmission of electrical energy by means of electromagnetic induction from a transmitting device of a track-guided vehicle to the trackside receiving device has the advantage as such of being tried and proven, even under the harsh operating conditions of track-guided traffic. For example, with balises, energy is transmitted from a vehicle-side balise antenna to the balise by means of electromagnetic induction, that is, by means of a magnetic field radiated from the balise antenna. However, the transmitted energy is used only for activating or reading the balise at the instant in which the vehicle passes over it. However, the transmitted energy is not stored beyond the point in time in which the vehicle passes over.

The power supply device according to the invention is fundamentally different from the known system consisting of a balise and a balise antenna in that it has a trackside energy storage device. This device is used for at least partial storage of the energy received by the trackside receiving device. By accordingly storing energy, it becomes advantageously possible to supply the at least one track element with electrical power by the process of transmitting the energy from the transmitting device to the trackside receiving device, with this supply being decoupled in time.

This is advantageous, since doing this also makes it possible to supply electrical power to operate track elements that must be supplied with electrical power independently of the passing of a track-guided vehicle, such as wheel sensors or axle counters. The wording “decoupled in time” is to be understood as meaning that the at least one track element is supplied with electrical power not only precisely when a track-guided vehicle passes over or passes by. This includes such cases in which the at least one track element is to be permanently supplied with electrical power. It is also possible that the at least one track element requires electrical power only temporarily, in which case the respective time periods may or may not be linked with the passing of a track-guided vehicle. It is thus conceivable, for example, that a track element is activated in preparation for a track-guided vehicle passing by and is to be supplied with electrical power from the energy storage device for this purpose. Alternatively or in addition to this, depending on the respective use case, the situation may also arise that a track element is activated by a track-guided vehicle passing by, also remains in operation for at least a certain period of time after the vehicle has passed by, and is operated during this time using electrical power from the energy storage device. The track element in question may, for example, be indirectly or directly activated by the transmitting device of the track-guided vehicle.

Furthermore, the power supply device according to the invention has the advantage that a variety of track-guided vehicles, particularly railbound vehicles, are already equipped with suitable transmitting devices, particularly in the form of balise antennas or Eurobalise antennas. Consequently, in many cases, the power supply device according to the invention can be implemented alone on the trackside, so that vehicle-side modifications can be avoided if possible.

It may be pointed out that the trackside receiving device can be configured not only in a point-shaped manner, approximately in the shape of an antenna, but also in a linear-shaped or planar manner. Corresponding embodiments have the advantage that they allow the transmission of a greater amount of energy due to longer coupling times or a larger coupling surface between the vehicle-side transmitting device and the trackside receiving device. In addition, it is conceivable that the trackside receiving device comprises a plurality of antennas or antenna elements, which can also optionally be spatially separated from each other, for example, on or in different tracks.

The power supply device according to the invention is preferably further developed in such a way that the power supply device is configured to supply the at least one track element with electrical power in a line-independent, autonomous manner. Here, the terms “line-independent” and “autonomous” are to be understood as meaning that an electrical connection of the at least one track element to a central power supply facility by means of an electrical line is not necessary. Instead, the electrical power required for the operation of the at least one track element is advantageously provided exclusively non-centrally by the power supply device. This brings about significant advantages with respect to the effort and expense associated with the design, implementation, and maintenance of the supply of track elements for track-guided traffic with electrical power.

The trackside energy storage device can in principle be implemented in any known manner. The only essential consideration is that full or at least partial storage of the energy received by the trackside receiving device when track-guided vehicles pass over or pass by one or a plurality of times is possible over a longer period of time, in order to enable a supply, which is decoupled in time, of the at least one track element with electrical power by the process of receiving energy from a vehicle passing by.

According to another particularly preferable embodiment of the power supply device according to the invention, the trackside energy storage device comprises at least one accumulator and/or at least one double-layer capacitor. This is advantageous, since accumulators are widely used and reliable components for storing energy. In addition, double-layer capacitors, which are also known as supercapacitors, are also becoming more widely used, particularly due to their high energy density. Furthermore, such double-layer capacitors are typically characterized by high reliability and a large number of possible charging cycles.

The trackside receiving device and the trackside energy storage device can be configured as respectively separate components as well as a collective component.

According to another particularly preferable development of the power supply device according to the invention, the trackside receiving device and/or the trackside energy storage device are configured as a component of the track element or one of the track elements. This offers the advantage of making it possible to achieve an especially compact design. However, for the case that the trackside receiving device is configured as a component of the track element or one of the track elements, this requires that the track element in question is arranged on the track, that is, for example, on or in the track, in such a way that it is possible for the trackside receiving device to receive the energy which is actively transmitted by means of electromagnetic induction by the transmitting device of the track-guided vehicle. Since this requirement will not exist in many cases, it might frequently be necessary or expedient to configure at least the trackside receiving device as a component that is separate from the track element or the track elements. However, the power supply device is preferably arranged in the immediate vicinity of the at least one track element to be supplied, that is, for example, at a distance of a few meters, in order to avoid laying longer cables between the trackside energy storage device and the at least one track element, if possible.

In principle, it is conceivable that the electrical power required for the operation of the track element or track elements is provided exclusively in the form of the energy that is transmitted or radiated by the transmitting device and received by the trackside receiving device. In order to ensure the reliability of the power supply device also in exceptional cases such as, for example, in the case of an extended track blockage that makes it impossible to receive energy from passing track-guided vehicles, it may be expedient for the power supply device to have another energy source.

According to another particularly preferable embodiment, the power supply device according to the invention also has at least one primary cell. This offers the advantage that it is possible to ensure continued operation of the track element or track elements, particularly in the case of malfunctions or extended operational interruptions. The power supply device preferably has a control device, which makes it possible to switch the power supply to the at least one primary cell if necessary, depending on the charging state of the energy storage device. In such a case, the power supply device is advantageously able to transmit a maintenance or alarm notification to a central control computer. The sending of such a notification or message preferably takes place wirelessly, for example, by means of a radio module which is either a component of the power supply device or can be connected to it using communication technology.

The power supply device according to the invention can advantageously also be further developed in such a way that the power supply device has at least one energy converter for generating electrical energy from the environment of the power supply device. This offers the advantage that electrical power can be additionally or alternatively provided for supplying the at least one track element by means of the at least one energy converter. The at least one energy converter is preferably connected to the energy storage device, which in this case is then used to store the energy received by means of electromagnetic induction from the transmitting device of the track-guided vehicle as well as to store the electrical energy generated by the energy converter. Providing an energy converter also offers the advantage that a corresponding redundant supply of electrical power increases the robustness and reliability of the power supply device. This is highly important particularly for supplying power to track elements for track-guided traffic, since such track elements frequently handle safety-related functions and must therefore be reliably protected from a failure.

In principle, the energy converter can be configured in any known manner for generating electrical energy from the environment or the energy in the environment of the power supply device. Such generation of energy from the environment is generally referred to as “energy harvesting.”

The power supply device according to the invention can preferably also be constructed in such a way that the at least one energy converter is configured to generate electrical energy from mechanical vibrations, light, heat, or wind. This offers the advantage that such energy converters are available on the market for a comparatively reasonable price. Thus, the energy converter can, for example, generate electrical energy from mechanical vibrations that are generated by passing track-guided vehicles. In comparison, the generation of electrical energy from light or heat offers the advantage that such energy converters are independent of the passing of track-guided vehicles. The same is also true in principle for the case in which the energy converter is configured for generating electrical energy from wind, in which case such wind can also include the air stream caused by a passing track-guided vehicle.

The present invention further comprises an apparatus having a power supply device according to the invention or a power supply device according to one of the previous preferred developments of the power supply device according to the invention, and having the transmitting device of the track-guided vehicle for actively transmitting energy by means of electromagnetic induction to the trackside receiving device.

According to a particularly preferred development of the apparatus according to the invention, the transmitting device is a balise antenna. The design of the transmitting device as a balise antenna, in particular, as a Eurobalise antenna, offers the advantage that track-guided vehicles in the form of rail vehicles normally already have respective balise antennas, so that the power supply device is advantageously not dependent on modifications or enhancements to the track-guided vehicles traveling on a track for its function or its operation.

In addition, the invention comprises an arrangement having a power supply device according to the invention or a power supply device according to one of the previous preferred developments of the power supply device according to the invention, and having the at least one track element.

The arrangement according to the invention is preferably further developed in such a way that the at least one track element is a wheel sensor, an axle counter, a switch, a signal, or a key interlock.

With respect to the method, the object of the present invention is to specify a method for supplying power to at least one track element for track-guided traffic that can be implemented in a comparatively simple manner while at the same time being versatile.

This object is achieved according to the invention by a method for supplying power to at least one track element for track-guided traffic, wherein energy is actively transmitted by a transmitting device of a track-guided vehicle by means of electromagnetic induction to a trackside receiving device, the energy received by the trackside receiving device is stored at least partially in a trackside energy storage device, and the at least one track element is supplied with electrical power by the trackside energy storage device, with this supply being decoupled in time from the transmission of the energy from the transmitting device to the trackside receiving device.

The advantages of the method according to the invention essentially correspond to the advantages already mentioned with respect to the power supply device according to the invention, so that reference is made in this regard to the corresponding embodiments above.

The invention is described in detail below based on an embodiment. The

FIGURE shows a schematic representation of an arrangement using an embodiment of the power supply device according to the invention.

The FIGURE depicts a track-guided vehicle 200 in the form of a rail vehicle, which travels on a track or a railroad track 300. Track elements 100 and 110 are arranged along the track, which can respectively be, for example, wheel sensors, axle counters, switches, signals, or key interlocks.

A power supply device 10 is provided on the trackside for supplying the track elements 100, 110 with electrical power. This power supply device comprises a trackside receiving device 20 for receiving energy that is actively transmitted by a transmitting device 210 of the track-guided vehicle 200 by means of electromagnetic induction. The corresponding energy transmission is indicated in the FIGURE by an arrow labeled with the identifier 70.

A trackside energy storage device 30 is electrically connected to the trackside receiving device 20, which is used for at least partial storage of the energy received by the trackside receiving device 20 and for supplying the at least one track element 100, 110 with electrical power from the energy received by the receiving device 20, with this supply being decoupled in time. It is thus possible for the trackside energy storage device 10 to supply the track elements 100 and 110 with electrical power even at times at which no track-guided vehicle 200 passes by the trackside receiving device 10 and thus no energy is transmitted from the track-guided vehicle 200 to the trackside receiving device 20 or to the trackside energy storage device 30. This is advantageous, since this also makes it possible to supply power to such track elements 100, 110, which must operate continuously or at least independently of the passing of a track-guided vehicle 200.

The power supply device 10 is advantageously configured to supply the track elements 100, 110 with electrical power in a line-independent, autonomous manner. This means that an additional line-dependent or cable-dependent feed of electrical power to the track elements 100, 110 is advantageously not necessary. Instead, the track elements 100, 110 are supplied with electrical power exclusively by the power supply device 10.

The trackside energy storage device 30 can, for example, be configured in such a way that it comprises at least one accumulator or also at least one double-layer capacitor. This makes it possible to store the energy in a reliable and long-lasting manner.

Within the scope of the described embodiment, the power supply device 10 also has a primary cell 40 or an arrangement of corresponding primary cells. The primary cell 40 acts as a fallback level in case the trackside energy storage device 30 is not capable of providing sufficient electrical power to supply the track elements 100 and 110. Such a situation could occur, for example, if a track is blocked for an extended time period, preventing vehicles 200 from running on the track 300, and thus meaning that the trackside receiving device 20 cannot receive energy from transmitting devices 210 of passing vehicles 200 for a corresponding time period. In order to ensure that the track elements 100, 110 also operate in such a situation, a switch 50 can be used to switch over the power supply to track elements 100, 110 from a supply via the trackside energy storage device 30 to a supply via the primary cell 40. Such a switchover process can be initiated, for example, depending on the charging state of the trackside energy storage device 30, via a control device, which is not shown in the FIGURE for reasons of clarity.

In addition to or alternatively to the primary cell 40, the power supply device 10 can also have an energy converter 60 for generating electrical energy from the environment or the energy in the environment of the power supply device 10. The energy converter 60 can generate electrical energy, for example, from mechanical vibrations, light, heat, or wind, and feed it into the trackside energy storage device 30. A corresponding energy converter 60 can thus also further increase the reliability of the power supply device 10.

The transmitting device 210 of the track-guided vehicle 200 can advantageously be a balise antenna, for example, in the form of a Eurobalise antenna. This offers the advantage that corresponding antennas are already regularly present on track-guided vehicles 200 in the form of rail vehicles. While balise antennas have previously been used only for reading balises arranged in the track and for providing the power required for performing the reading, the power supply device 10 advantageously makes it possible to make them available in the form of electrical power to the track elements 100 and 110, which can be track elements of any kind, in a manner that is decoupled in time from the transmission and storage of the energy.

It may be pointed out that that the track elements 100, 110 are advantageously not only independent of the laying of cables to a central power supply facility with respect to the power supply, but are also preferably configured for wireless communication with central control devices, for example, in the form of control or master computers in a signal box. This offers the advantage that it is possible to dispense with a cable or line connection of the track elements 100, 110 to central supply or control components not only with respect to the power supply, but also with respect to data or communication lines.

According to the above embodiments, the described power supply device 10 particularly offers the advantage that it enables dispensing with laying cables for any types of track elements 100, 110 to a central power supply facility that is located far from the location of the respective track element 100, 110. This results in substantial advantages in practice for the design and operation of track-guided traffic facilities with respect to flexibility in providing track elements and with respect to the associated effort and expense incurred.

1-12. (canceled)

13. A power supply device for a track element of track-guided traffic, the device comprising:
a trackside receiving device disposed in vicinity of a track and configured for receiving inductively transferred energy that is transmitted actively by way of electromagnetic induction from a transmitting device of a track-guided vehicle;
a trackside energy storage device connected to said receiving device for at least partial storage of the energy received by said trackside receiving device; and
said energy storage device being configured for supplying the track element with electrical power temporaneously decoupled from the inductive energy transfer from the transmitting device to the trackside receiving device.

14. The power supply device according to claim 13, wherein said power supply device is configured to supply the track element with electrical power in a line-independent, autonomous manner.

15. The power supply device according to claim 13, wherein said trackside energy storage device comprises at least one device selected from the group consisting of an accumulator and a double-layer capacitor.

16. The power supply device according to claim 13, wherein said trackside receiving device and/or said trackside energy storage device are configured as a component of the track element.

17. The power supply device according to claim 16, wherein the track element is one of a plurality of track elements and said trackside receiving device and/or said trackside energy storage device are configured as a component of one of the track elements.

18. The power supply device according to claim 13, which further comprises at least one primary cell.

19. The power supply device according to claim 13, which further comprises at least one energy converter for generating electrical energy from an environment of the power supply device.

20. The power supply device according to claim 19, wherein said at least one energy converter is configured to generate electrical energy from mechanical vibrations, from light, from heat, or from wind.

21. An apparatus, comprising:
a power supply device according to claim 13; and
a transmitting device of a track-guided vehicle for actively transferring energy by way of electromagnetic induction to the trackside receiving device of said power supply device.

22. The apparatus according to claim 21, wherein said transmitting device is a balise antenna.

23. A trackside assembly, comprising: a power supply device according to claim 13 and at least one track element connected to said power supply device.

24. The assembly according to claim 23, wherein said at least one track element is a device selected from the group consisting of a wheel sensor, an axle counter, a switch, a signal, and a key interlock.

25. A method for supplying power to at least one track element of a track-bound traffic system, the method comprising:
actively transmitting energy from a transmitting device of a track-guided vehicle by way of electromagnetic induction to a trackside receiving device;
storing the energy received by the trackside receiving device at least partially in a trackside energy storage device; and
supplying the at least one track element with electrical power from the trackside energy storage device;
wherein the supplying step is temporaneously decoupled from the transmission of the energy from the transmitting device to the trackside receiving device.
